(19) United States
(12) Patent Application Publication
(10) Pub. No.: US 2006/0030228 A1
(43) Pub. Date: Feb. 9, 2006

(54) High-visibility, flame resistant fabrics and methods for making same

(76) Inventor: Rembert J. Truesdale III, Thomaston, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/197,829

(22) Filed: Aug. 5, 2005

Related U.S. Application Data
(60) Provisional application No. 60/599,367, filed on Aug. 6, 2004.

(51) Int. Cl. B32B 27/04; B32B 27/12; B32B 5/02; B32B 27/02; B32B 9/04

(52) U.S. Cl. 442/136; 442/153; 442/164

(57) ABSTRACT

High-visibility, flame resistant fabrics and methods for making such fabrics. In one embodiment, a high-visibility, flame resistant fabric includes a plurality of flame resistant cellulosic fibers, wherein the fabric has been dyed a high-visibility shade that complies with ANSI 107-1999.

### CROSS-REFERENCE TO RELATED APPLICATION

This application claims priority to copending U.S. provisional application entitled, “High-Visibility, Flame Resistant Fabrics and Methods for Making Same” having Ser. No. 60/599,367, filed Aug. 6, 2004, which is entirely incorporated herein by reference.

### BACKGROUND

High-visibility garments are often used by various utility personnel and other outdoor workers in environments in which it is considered important to be able to see the wearer. For instance, utility linemen frequently wear high-visibility gear (e.g., coats, vests, and/or pants) when working near roadways that help passing drivers identify the linemen while they do their jobs. Due to the importance of being able to identify such persons, the American National Standards Institute (ANSI) has developed a standard for high-visibility safety apparel known in the industry as ANSI 107-1999. According to this standard, qualifying garments must exhibit high-visibility. For example, under ANSI 107-1999, compliant high-visibility fluorescent yellow-green apparel must exhibit x and y chromaticity coordinates within the region bounded by the (x.y) values of (0.387, 0.610), (0.356, 0.494), (0.398, 0.452), and (0.460, 0.540), and must have a minimum luminance factor (β min) of 0.76.

Given that certain personnel, such as utility linemen, are also exposed to environments in which electric arcs and/or flames may be encountered, some high-visibility garments are constructed of flame resistant material. One popular material for the construction of high-visibility, flame resistant garments is modacrylic. As is known in the art, modacrylic, in most forms, is inherently flame resistant so as to self-extinguish if ignited, and can be dyed to a high-visibility color that satisfies ANSI 107-1999.

Despite being inherently flame resistant and dyeable so as to comply with ANSI 107-1999, modacrylic fabric is undesirable from a thermal shrinkage perspective. In particular, although modacrylic fabric self-extinguishes when ignited, such modacrylic fabric shrinks significantly when exposed to high temperatures. Beyond merely damaging the garment, such shrinkage is potentially dangerous to the wearer in that the wearer may be burned as a result. In addition, in cases in which the modacrylic fabric is used as an outer layer of a garment that includes an internal insulation layer, such shrinkage can undermine the insulative properties of such an insulation layer by compressing the layer so as to reduce the amount of insulating air space that the insulative layer provides.

### SUMMARY

Disclosed are high-visibility, flame resistant fabrics and methods for making such fabrics. In one embodiment, a high-visibility, flame resistant fabric includes a plurality of flame resistant cellulosic fibers, wherein the fabric has been dyed a high-visibility shade that complies with ANSI 107-1999.

### DETAILED DESCRIPTION

As can be appreciated from the foregoing, a high-visibility, flame resistant fabric which is resistant to thermal shrinkage would be desirable. As is described in the following, such high-visibility, flame resistant fabrics can be constructed by dyeing a fabric that contains flame resistant cellulosic fibers, such as flame resistant (FR) rayon, to a high-visibility shade of color. As is known in the art, it can be difficult to dye cellulosic fabrics so as to achieve high-visibility shades that comply with ANSI 107-1999. However, as is described below, it has been discovered that fabrics that comprise such cellulosics can be dyed to a compliant high-visibility shade.

The disclosed fabric comprises FR cellulosic fibers. The designation “FR” indicates that the fibers contain a flame retardant compound that renders the cellulosic fibers (which are not inherently flame resistant) flame resistant. Suitable flame retardants may comprise, for instance, phosphorus compounds such as Sandolast 9000™, currently available from the Clariant Corporation (formerly Sandoz), antimony compounds, and the like. Possible FR cellulosic fibers include, for example, FR rayon, FR cotton, FR acetate, FR triacetate, and FR lyocell. In some embodiments, the flame resistant compound(s) may be added to the fibers during fabric processing, for instance as a post-dyeing treatment. Accordingly, the FR cellulosic fibers may be flame resistant due, at least in part, to that processing. In some cases, the cellulosic fibers may not comprise any flame retardant until such processing is performed.

Although the fabric can be composed exclusively of cellulosic fibers, for instance exclusively of FR cellulosic fibers, the fabric can, alternatively, comprise a blend of cellulosic fibers and other fibers that change the characteristics of the fabric. By way of example, the FR cellulosic fibers may be blended with inherently flame resistant fibers, such as aramid fibers including para-aramid fibers (e.g., Kevlar™ fibers) and/or meta-aramid fibers (e.g., Nomex™ fibers), and modacrylic fibers. Although modacrylic fibers are not resistant to thermal shrinkage, a relatively low percentage of modacrylic fibers will not unduly compromise the fabric as a whole.

When the FR cellulosic fibers are blended with other fibers, the FR cellulosic component may comprise a high percentage of the fabric composition by weight. For instance, the fabric may comprise approximately between 5% and 100% FR cellulosic fibers. In some embodiments, the fabric may comprise approximately 20% to 80% FR or 40% to 50% FR cellulosic fibers.

The resultant fabric typically has a weight of approximately 3 to 10 ounces per square yard (osy). By way of example, the fabric has a weight of one of 4.5 osy, 5.5 osy, 6.5 osy, and 7.5 osy.

When FR cellulosic fibers, or a blend of such fibers and other flame resistant fibers, are used, the resultant fabric is highly flame resistant. By way of example, the fabrics comply with standards espoused by the National Fire Protection Agency (NFPA). More particularly, the fabrics comply with one or more of NFPA 70E and NFPA 2112, which pertain to electric arc protection and flash fire protection, respectively.

Once the desired flame resistant fabric is constructed, the fabric can be piece dyed to a high-visibility shade so as to comply with ANSI 107-1999. In cases in which the fabric comprises a blend of FR cellulosic fibers and other flame resistant fibers, the fabric can be union dyed such that each component of the fabric is dyed to the high-visibility shade.

In cases in which a 100% FR cellulosic fabric is used, the fabric can be dyed using an exhaust process. In this process, a dye is added to an alkaline medium to form a dye bath in which the fabric can be immersed. Immersion can be achieved, for example, by loading a roll of fabric into a jet dyer, such as a pressure jet dyeing vessel, in which the fabric can be circulated through an apertured venturi contained within the vessel. In such a dye method, the ends of the fabric are sewn together to form a continuous loop. The fabric is then scoured by passing it through an aqueous solution that passes through the apertures in the venturi and impinges the fabric. After scouring has been completed, the jet is again charged with the selected dye bath. By way of example, the dye is provided in a concentration of approximately 0.05% to 12% on weight of fabric (owf). Alternatively, dyeing can be achieved with a beam, beck, or jig dyeing apparatus.

The dye is selected so as to achieve dyeing of the FR cellulosic fibers to a full, high-visibility shade. Preferred for dyeing the FR cellulosic fibers are fluorescent shades of direct (e.g., yellow and orange), reactive (e.g., yellow, orange, and red), azoic (e.g., orange and red) dyes, vat (e.g., orange) dyes, and mixtures thereof.

In addition to the dye, a flame retardant compound can also be included in the dye bath, applied as an after-dyeing surface treatment, or otherwise incorporated in the fabric fibers to enhance flame resistance or to counteract any deleterious effects of the dyeing process. Example flame retardants include Antiblaze 80™ (“AB80™”) and Antiblaze 100™ (“AB100™”), which are both currently available from Rhodia.

The temperature of the dye bath is gradually increased from room temperature to a peak temperature below the boiling point, such a temperature in the range of approximately 130° F. to 180° F. This gradual increase in temperature is thought to promote even and uniform coloration. Upon reaching the predetermined peak temperature, the dye bath is maintained at this peak temperature for about 20 to 60 minutes to allow dye to fully penetrate the FR cellulosic fibers. After the expiration of that time period, the dye bath is cooled until the fabric is at a temperature at which it can be handled. At this time, the dye bath is discarded and the fabric is again scoured to remove the majority of chemicals contained in the fabric.

In cases in which a blend of FR cellulosic fibers and other flame resistant fibers is to be dyed, the blend can be union dyed using a multi-step (e.g., two-step) exhaust dye process. Although a multi-step process is identified herein, a one-step process can be used in which the FR cellulosic fibers and the other fibers are dyed in a single dye process. Assuming for purposes of example that a two-step dye process is used, the FR cellulosic fibers are, for example, dyed in a first dye bath in the manner described above and the other fibers are dyed in a separate dye bath. Notably, the FR cellulosic fibers can be dyed either before or after the other fibers are dyed.

Although inherently flame resistant fibers, such as aramid fibers, are often dyed at high temperatures, dyeing of the disclosed fabric blends may be conducted at low temperatures, i.e. below 100° C., to avoid depleting the flame retardants contained in the FR cellulosic fibers. Despite the perceived difficulty in the industry in dyeing inherently flame resistant fibers, such as aramids (and para-aramid in particular), at such low temperatures, the inherently flame resistant fibers of the fabric can be dyed a full shade of color using the methods described below. It is to be noted that, for the purposes of this disclosure, the term “full shade” denotes penetration of the subject fiber with dye stuff and fixation of the dye stuff therein, as opposed to mere superficial staining of the fibers.

The fabric blends can be dyed using customary dyeing equipment, such as dye jets or other appropriate dye equipment. Typically, a dye and a dye-assistant for the inherently flame resistant fibers are combined to form a mixture (e.g., a dye bath, solution, dispersion, or the like). The fabric is then contacted with this mixture, typically by immersion, and the mixture is heated until the dye is fixed in the inherently flame resistant fibers.

Preferred dye-assistants for the inherently flame resistant fibers are selected from N-cyclohexylpyrrolidone, benzyl alcohol, N,N-dibutylformamide, N,N-diethylbenzamide, hexadecyltrimethyl ammonium salt, N,N-dimethylbenzamide, N,N-diethyl-m-toluamide, N-octylpyrrolidone, aryl ether, Halcomid M-8/10 (an approximately 50/50 blend of N,N-dimethylcaprylamide and N,N-dimethylcapramide), and mixtures thereof. As an alternative to adding dye-assistant to the dye bath, the dye-assistant can instead be imbibed into the fibers during production. Exemplary of the types of fibers that can be dyed in this manner are those disclosed by Vance et al. in U.S. Pat. No. 4,688,234, and Hodge et al. in U.S. Pat. No. 5,074,889, both of which are hereby incorporated by reference. As is disclosed by Vance et al., a surfactant such as hexadecyltrimethylammonium salt or isopropylammonium dodecylbenzenesulfonate is typically added to the fiber at a level of approximately 5% to 15% by weight. When the fibers are imbibed with dye-assistant, no additional dye-assistant need be added to the dye bath.

Dyes that can be used to dye the inherently flame resistant fibers, and particularly aramid fibers, include fluorescent acid (e.g., yellow and red), basic (e.g., yellow and red), disperse (e.g., yellow and red), and mixtures thereof. Of these dyes, particularly preferred is a fluorescent basic or acid dye.

As is described above, the high temperatures conventionally deemed necessary to attain adequate dyeing of the inherently flame resistant fibers deplete the flame retardant contained in the cellulosic fibers. To avoid this problem, the inherently flame resistant fibers are dyed at temperatures below 100° C. Typically, temperatures from approximately 70° C. to 100° C. are used, for instance 85° C. However, temperatures as low as 60° C. and even 50° C. can be used to dye the inherently flame resistant fibers.

To conduct dyeing of the inherently flame resistant fibers, the selected dye and dye-assistant are applied to the fibers of the fabric through immersion. Immersion can be achieved, for example, by loading a roll of fabric into a jet dyer such as a pressure jet dyeing vessel in which the fabric can be circulated through a apertured venturi contained within the vessel. Once loaded into the vessel, the ends of the fabric are sewn together to form a continuous loop. The fabric is then scoured by passing it through an aqueous solution that passes through the apertures in the venturi and impinges the fabric. After scouring has been completed, the jet is again charged with water, the selected dye and dye-assistant. By way of example, the dye is provided in a concentration of approximately 0.01% to 12% owf. Alternatively, where dye-assistant has been imbibed into the fibers, no additional dye-assistant is added to the dye bath since an adequate amount of dye-assistant is typically already contained within the fibers themselves. In such circumstances, the same dye steps apply with the exception of the step of adding dye-assistant to the dye bath.

The temperature of the dye bath is gradually increased from room temperature to a predetermined peak temperature between approximately 50° C. to 100° C. Upon reaching the predetermined peak temperature, the dye bath is maintained at this peak temperature for about 30 to 90 minutes to allow dye to fully penetrate the fibers. It will be appreciated that since the dyeing temperature range does not reach 100° C., there is no need to increase the pressure of the dye bath beyond atmospheric pressure to prevent boiling. Therefore, all dyeing can be conducted at constant ambient atmospheric pressure, although a closed vessel and increased pressure may be used to reduce foaming or control odors.

After the expiration of approximately 30 to 90 minutes at the peak temperature, the dye bath is cooled until the fabric is at a temperature at which it can be handled. At this time, the dye bath is discarded and the fabric is again scoured to remove excess dye-assistant or other chemicals contained in the fabric.

After all dyeing has been completed, the fabric then can be finished in conventional manner. This finishing process can include the application of FR treatments, wicking agents, water repellents, stiffening agents, softeners, and the like. At this stage, the finished fabric normally contains residual dye-assistant in a concentration of approximately 0.5% to 10% owf, depending on the dye-assistant used and total processing. Typically, it is preferred to keep the levels of residual dye-assistants in the lower portion of the range, approximately between 0.5% and 5.0% owf.

Table I provides examples of dyes that may be used in the processes described in the foregoing.

TABLE I

| | | |
|---|---|---|
| Dye | Salt | Color |

Azoic (Cellulosic Component)

| | | |
|---|---|---|
| Fast red B | Napthol AS | Red |
| Fast red B | Napthol ASOL | Red |
| Fast red KB | Napthol AS | Red |
| Fast orange RD | Napthol ASD | Orange |
| Fast orange RD | Napthol ASKB | Red |
| Fast orange RD | Napthol ASOL | Orange |
| Fast orange RD | Napthol AS | Orange |
| Fast scarlet G | Napthol ASD | Red |
| Fast scarlet G | Napthol AS | Red |
| Fast scarlet G | Napthol ASKB | Red |
| Fast scarlet G | Napthol ASPH | Orange |
| Fast scarlet R | Napthol ASOL | Red |
| Fast scarlet R | Napthol ASD | Red |

| | |
|---|---|
| Dye | Color |

Direct (Cellulosic Component)

| Solophenyl flavine 7GFF | Yellow |
|---|---|
| Solophenyl red 4GE | Red |
| Direct Yellow 277 | Yellow |
| Dye | Color |

Fiber Reactive (Cellulosic Component)

| Remazol luminous yellow | Yellow |
|---|---|
| Remazol luminous orange RR | Orange |
| Dye | Color |

Vat (Cellulosic Component)

| CI vat orange 7 | Orange |
|---|---|
| Dye | Color |

Acid (Aramid Component)

| Acid yellow 184 | Yellow |
|---|---|
| Acid red 52 | Red |
| Dye | Color |

Basic (Aramid Component)

| Basic yellow 40 | Yellow |
|---|---|
| Basic red 15 | Red |
| Basic violet 16 | Violet |
| Basic red 14 | Red |
| Dye | Color |

Disperse (Aramid Component)

| | |
|---|---|
| Dianix luminous yellow | Yellow |
| Dianix luminous red G | Red |
| Dianix luminous red B | Red |
| Dianix luminous red 3B | Red |
| Dianix luminous pink 5B | Pink |

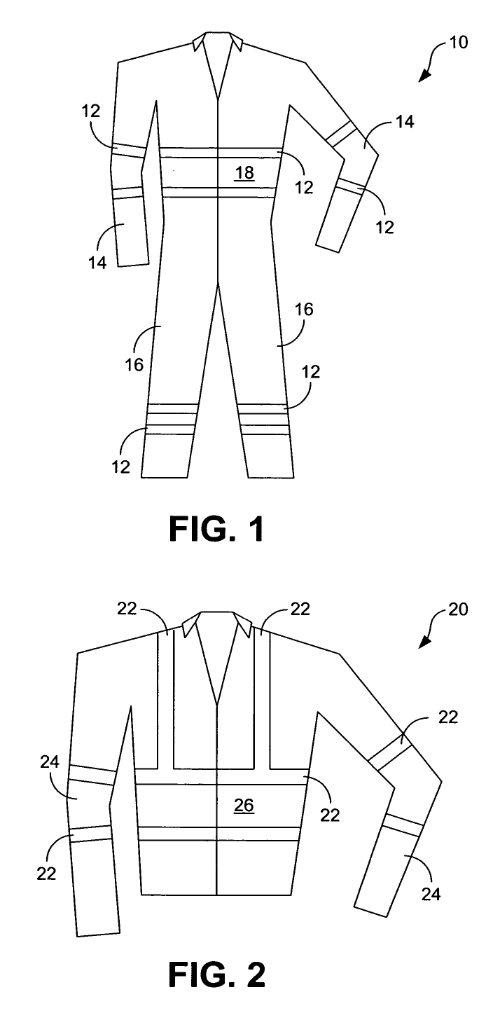

The above-described fabrics can be used to construct various garments. Example garments are illustrated in FIGS. 1-4. Beginning with FIG. 1, shown is a coverall or jumpsuit 10. The entire or nearly the entire jumpsuit 10 is composed of one or more of the fabric materials discussed in the foregoing. In addition, the jumpsuit 10 comprises a plurality of discretely-positioned retroreflective elements 12, such as strips of retroreflective tape. As is indicated in FIG. 1, the retroreflective elements 12 can be provided on the sleeves 14, pant legs 16, and torso 18 of the jumpsuit 10.

Referring next to FIG. 2, illustrated is a jacket 20. The jacket 20 is also constructed of one or more of the fabric materials discussed in the foregoing and also includes retroreflective elements 22 that are provided on the sleeves 24 and torso 26 of the jacket.

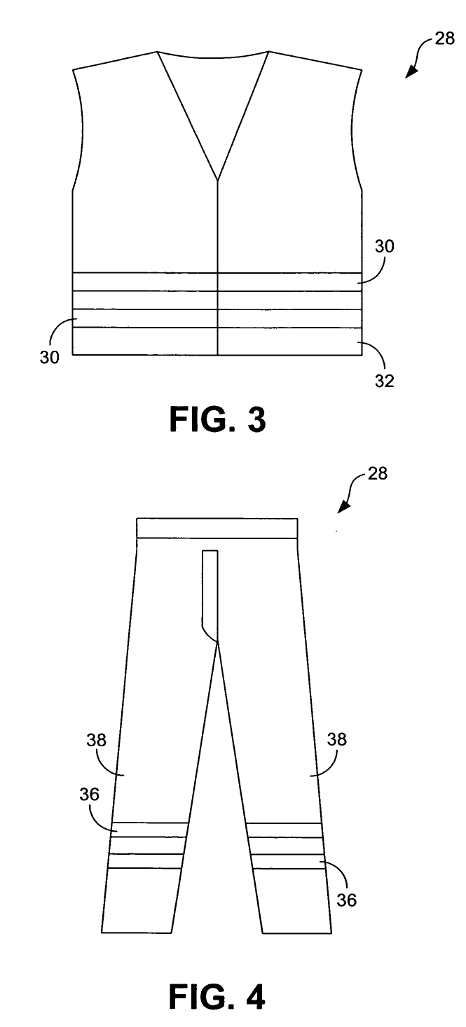

FIG. 3 illustrates a vest 28 also constructed of one or more of the fabric materials discussed in the foregoing. The vest 28 includes retroreflective elements 30 positioned at a midsection 32 of the vest.

Finally, FIG. 4 illustrates trousers 34 that are constructed of one or more of the fabric materials discussed in the foregoing. The trousers 34 include retroreflective elements 36 positioned on the legs 38 of the trousers.

Although various specific materials have been described above for blending with FR cellulosic materials to form high-visibility, flame resistant fabrics and garments, other materials may be used. For example, in some embodiments, wool may be added into the fabric blend.

Claimed is:

1. A high-visibility, flame resistant fabric, comprising:
a plurality of flame resistant cellulosic fibers;
wherein the fabric has been dyed a high-visibility shade that complies with ANSI 107-1999.

2. The fabric of claim 1, wherein the flame resistant cellulosic fibers comprise one or more of flame resistant rayon, flame resistant cotton, flame resistant acetate, flame resistant triacetate, and flame resistant lyocell.

3. The fabric of claim 1, wherein the fabric is exclusively composed of flame resistant cellulosic fibers.

4. The fabric of claim 1, further comprising a plurality of inherently flame resistant fibers.

5. The fabric of claim 4, wherein the inherently flame resistant fibers comprise one or both of aramid fibers and modacrylic fibers.

6. The fabric of claim 4, wherein the fabric comprises approximately between 5% and 100% flame resistant cellulosic fibers.

7. The fabric of claim 4, wherein the fabric comprises approximately between 20% and 80% flame resistant cellulosic fibers.

8. The fabric of claim 1, wherein the fabric has a weight of approximately 3 to 10 ounces per square yard.

9. The fabric of claim 1, wherein the fabric is dyed one of fluorescent yellow, fluorescent orange, or fluorescent red.

10. A high-visibility, flame resistant fabric, comprising:
a plurality of flame resistant cellulosic fibers comprising at least one of flame resistant rayon, flame resistant cotton, flame resistant acetate, flame resistant triacetate, and flame resistant lyocell; and
a plurality of inherently flame resistant fibers comprising one or both of aramid fibers and modacrylic fibers;
wherein the fabric has been dyed a high-visibility, fluorescent shade that complies with ANSI 107-1999 and has flame resistance that complies with NFPA 2112;
wherein fabric is comprised of approximately between 20% and 80% flame resistant cellulosic fibers.

11. A method for producing a high-visibility, flame resistant fabric, comprising:
forming a fabric comprising a plurality of flame resistant cellulosic fibers; and
dyeing the fabric a high-visibility shade that complies with ANSI 107-1999.

12. The method of claim 11, wherein forming a fabric comprises forming a fabric comprising a plurality of the flame resistant cellulosic fibers that comprise one or more of flame resistant rayon, flame resistant cotton, flame resistant acetate, flame resistant triacetate, and flame resistant lyocell.

13. The method of claim 11, wherein forming a fabric comprises forming a fabric that is exclusively composed of flame resistant cellulosic fibers.

14. The method of claim 11, wherein forming a fabric further comprises forming the fabric to comprise a plurality of inherently flame resistant fibers.

15. The method of claim 14, wherein forming a fabric to comprise a plurality of inherently flame resistant fibers comprises forming the fabric to comprise one or both of aramid fibers and modacrylic fibers.

16. The method of claim 11, wherein dyeing the fabric comprises dyeing the fabric in a piece-dyeing process.

17. The method of claim 11, wherein dyeing the fabric comprises dyeing the fabric using fluorescent shades of one or more of direct, reactive, azoic, and vat dyes.

18. The method of claim 11, wherein dyeing the fabric comprises dyeing the fabric using fluorescent shades of one or more of acid, basic, and disperse dyes.

19. The method of claim 11, wherein dyeing the fabric comprises dyeing the fabric using a dye-assistant selected from the group comprising N-cyclohexylpyrrolidone, benzyl alcohol, N,N-dibutylformamide, N,N-diethylbenzamide, hexadecyltrimethyl ammonium salt, N,N-dimethylbenzamide, N,N-diethyl-m-toluamide, N-octylpyrrolidone, aryl ether, Halcomid M-8/10, and mixtures thereof

20. The method of claim 11, wherein dyeing the fabric comprises dyeing the fabric one of fluorescent yellow, fluorescent orange, or fluorescent red.

21. The method of claim 11, wherein dyeing the fabric comprises dyeing the fabric at a temperature of approximately 70° C. to 100° C.

22. The method of claim 11, wherein dyeing the fabric comprises dyeing the fabric at a temperature below 100° C.

23. A high-visibility garment, comprising:
a high-visibility, flame resistant fabric that comprises a plurality of flame resistant cellulosic fibers that comprise one or more of flame resistant rayon, flame resistant cotton, flame resistant acetate, flame resistant triacetate, and flame resistant lyocell, wherein the fabric has been dyed a high-visibility shade that complies with ANSI 107-1999.

24. The garment of claim 23, wherein the high-visibility, flame resistant fabric further comprises a plurality of inherently flame resistant fibers that comprise one or both of aramid fibers and modacrylic fibers.

25. The garment of claim 24, wherein the fabric comprises approximately between 5% and 100% flame resistant cellulosic fibers.

26. The garment of claim 24, wherein the fabric comprises approximately between 20% and 80% flame resistant cellulosic fibers.

27. The garment of claim 23, wherein the fabric is dyed one of fluorescent yellow, fluorescent orange, or fluorescent red.

28. The garment of claim 23, further comprising retroreflective elements.

29. The garment of claim 28, wherein the retroreflective elements comprise retroreflective tape.

30. The garment of claim 23, wherein the garment comprises one of a jumpsuit, a jacket, a vest, and trousers.
